(19) United States
(12) Patent Application Publication
(10) Pub. No.: US 2015/0356879 A1
(43) Pub. Date: Dec. 10, 2015

(54) GPS Based Instructional Driving Simulation Device

(71) Applicant: Timothy Best, Greenville, NC (US)

(72) Inventor: Timothy Best, Greenville, NC (US)

(21) Appl. No.: 14/552,211

(22) Filed: Nov. 24, 2014

Related U.S. Application Data
(60) Provisional application No. 61/997,730, filed on Jun. 9, 2014.

(51) Int. Cl. G09B 9/04

(52) U.S. Cl. CPC G09B 9/04

(57) ABSTRACT

A global positioning system (GPS) based instructional driving simulation device presents a means for a user to learn to drive an automobile in a virtual setting. The virtual setting is produced through software on a data storage device which is processed through a central processing unit (CPU) and displayed through use a graphically processing unit (GPU). The GPU outputs a video signal through a display adapter to an external monitor that is ultimately displayed to the user. The user controls the virtual automobile through a control panel. The control panel is located on a dashboard which is positioned in front of the user during use. The dashboard is part of an enclosure that houses the electronic components of the GPS based instructional driving simulation device. The presented device allows the user to learn driving standards and practices before operate a physical automobile.

The current application claims a priority to the U.S. Provisional Patent application Ser. No. 61/997,730 filed on Jun. 9, 2014.

### FIELD OF THE INVENTION

The present invention relates generally to an apparatus to teach children how to drive at an earlier age without putting them directly behind the wheel of a vehicle. More specifically, the present invention uses a global positioning system to display a virtual vehicle on a map.

### BACKGROUND OF THE INVENTION

Within the United States, each state has different laws regarding the age of which a person may apply for a restricted driving license. In addition to the age of the applicant, each state includes different requirements for the application of their state's full driver's license. Introducing a new driver to a vehicle can be intimidating to both the driver and the instructor. It is beneficial to both the new driver and the instructor for the new driver to become as familiar as possible with the concepts and practices for being a safe driver before getting behind the wheel of an automobile.

The present invention provides a means to introduce a person to the concepts of driving by allowing them to mimic the movements of a moving vehicle which they may be seated in. The present invention makes use of a global positioning system to display a virtual automobile that is able to be controlled through a control panel located on the present invention. The GPS based instructional driving simulation device is able to output a display signal to a headrest monitor, headrest, television, tablet, computer, or similar computing device, allowing the user to ask questions to their parents or instructors regarding the operation of an automobile. The present invention includes a steering mechanism, a means for accelerating and decelerating, and a means for controlling the transmission controller of the virtual vehicle.

### BRIEF DESCRIPTION OF THE DRAWINGS

FIG. 1 is a perspective view of the present invention.

FIG. 2 is a front view of the present invention.

FIG. 3 is a back view of the present invention.

FIG. 4 is a left view of the present invention.

FIG. 5 is a right view of the present invention.

FIG. 6 is a top view of the present invention.

FIG. 7 is a block diagram of the subcomponents for the control panel.

FIG. 8 is a block diagram of the subcomponents for the performance display.

FIG. 9 is a general schematic of the electrical components.

### DETAIL DESCRIPTIONS OF THE INVENTION

All illustrations of the drawings are for the purpose of describing selected versions of the present invention and are not intended to limit the scope of the present invention.

The present invention is for a global positioning system (GPS) based instructional driving simulation device, which allows a user to learn how operate an automobile in a virtual setting. Due to the virtual setting, people may learn to drive at an earlier age without the risk injuring the driver, passengers, and pedestrians or causing property damage.

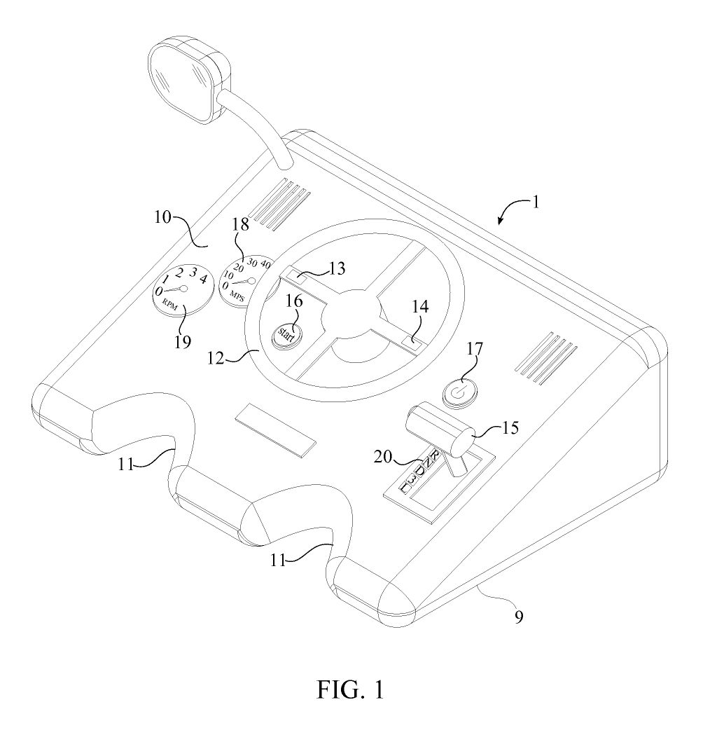

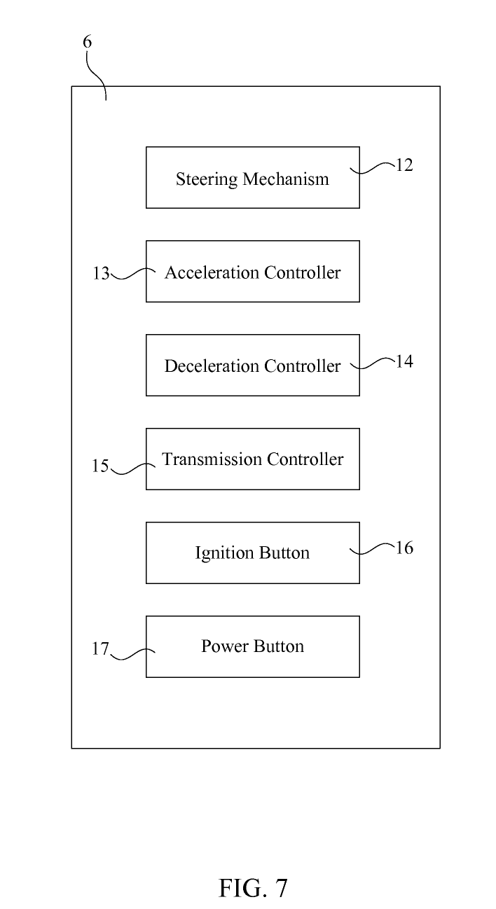

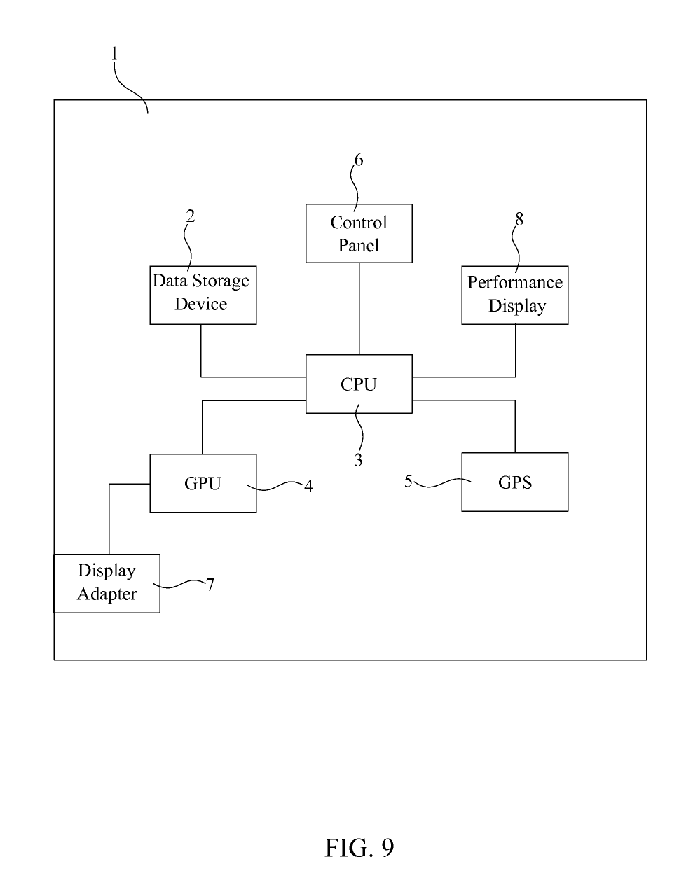

As illustrated in FIG. 1 and FIG. 9, the GPS based instructional driving simulation device comprises an enclosure 1, a data storage device 2, a central processing unit (CPU) 3, a graphical processing unit (GPU) 4, a global positioning system (GPS) 5, a control panel 6, and display adapter 7. The enclosure 1 comprises a base 9 and a dashboard 10. The enclosure 1 houses the electronic components and supports the user interface, where the data storage device 2, the CPU 3, the GPU 4 and the GPS 5 are positioned within the enclosure 1. The control panel 6 provides the user with an interface to operate the present invention, which is mounted onto the dashboard 10. Detailed in FIG. 7, the control panel 6 comprises a steering mechanism 12 which the user manipulates to control the virtual automobile. The steering mechanism 12 is adjacently and centrally positioned on the dashboard 10, such that the user can easily access and interact with the steering mechanism 12. The control panel 6 and the GPS 5 are electronically connected to the CPU 3, such that the signals from both of these units are centrally processed and properly inputted from and outputted to the user. The CPU 3 is electronically connected to the data storage device 2 such that the software can be called the information processed to determine how the inputs from the user are controlled. The CPU 3 is electronically connected to the display adapter 7 through the GPU 4. The GPU 4 uses the input from the CPU 3 and the software stored on the data storage device 2 through the CPU 3 to create an output graphical display signal that the user ultimately sees. The display adapter 7 allows the output signal to be displayed on an external display such as a computer monitor, a tablet, mounted headrest monitors of an automobile, etc.

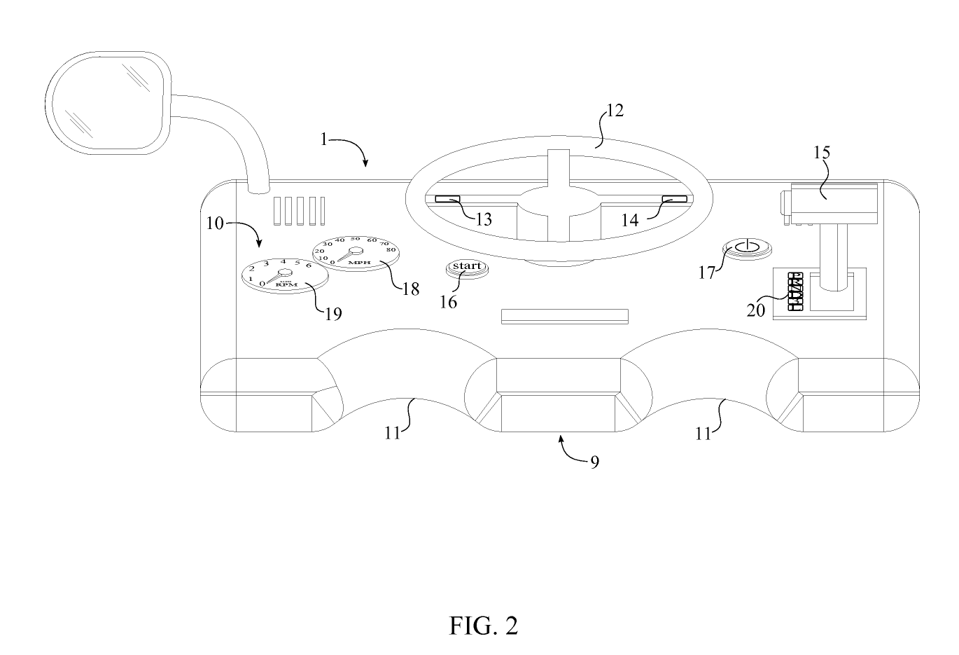

Further detailed in FIG. 2 and FIG. 7, the control panel 6 comprises an acceleration controller 13, a deceleration controller 14, a transmission controller 15, an ignition button 16, and a power button 17. The acceleration controller 13, the deceleration controller 14, the transmission controller 15, the ignition button 16, and the power button 17 are electronically connected to the CPU 3, such that the CPU 3 can process the user inputs. The acceleration controller 13 increases the speed of the virtual automobile while the deceleration controller 14 decreases the speed of the virtual automobile. The acceleration controller 13 and the deceleration controller 14 can be, but is not limited to, a pair of paddle shifters or a pair of buttons operatively mounted onto a steering wheel of the steering mechanism 12. The transmission controller 15 mimics the gear shifting mechanism for an automobile such that the user can control if the virtual car is going forward or backward, and control the gear ratio from the engine to the wheels. The transmission controller 15 is either designed for an automatic transmission or a manual transmission. The ignition button 16 starts the “engine” of the virtual automobile allowing the virtual automobile to move as a physical automobile. The power button 17 turns the present invention on and off. The transmission controller 15, the ignition button 16, and the power button 17 are mounted onto the dashboard 10 so the user can easily access them during use.

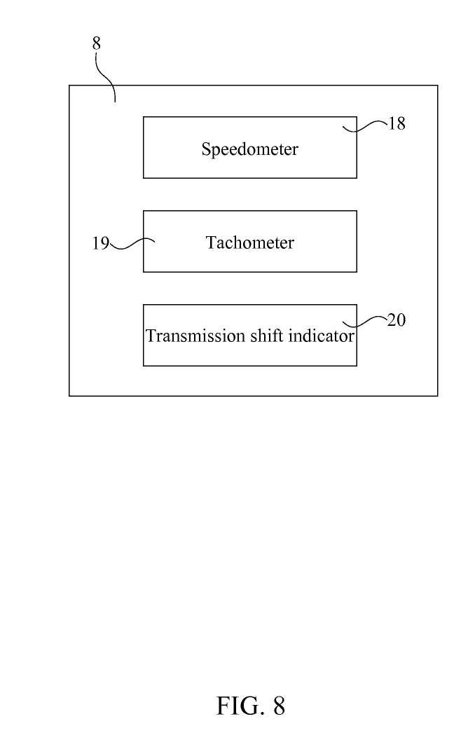

In the preferred embodiment of the present invention, the present invention further comprises a performance display 8, as shown in FIG. 8. The performance display 8 displays various performance indicators such as revolutions per minute, speed, engine temperature, current gear, etc. The performance display 8 comprises a speedometer 18, a transmission shift indicator 20, and a tachometer 19. The speedometer 18 presents the speed of the virtual vehicle to the user, while the tachometer 19 displays the revolutions of the virtual automobile engine's crankshaft. The transmission shift indicator 20 allows the user to identifies and choose the gear ratio of the vehicle for operation. While it is preferred that the speedometer 18, the tachometer 19 and the transmission shift indicator 20 are mounted on the dashboard 10, the display values may be included in the display output of the present invention and viewed on the external display device.

In the preferred embodiment of the present invention where the speedometer 18, tachometer 19, and transmission shift indicator 20 are mounted on the dashboard 10, the aforementioned are arranged, along with the control panel 6, such that the user can view performance display 8 and operate the control panel 6 efficiently and effectively. The steering mechanism 12 is positioned between the tachometer 19 and the transmission controller 15. The speedometer 18 is positioned between the tachometer 19 and the steering mechanism 12. The ignition button 16 is positioned between and equidistant to both the speedometer 18 and the steering mechanism 12. The power button 17 is positioned between the transmission controller 15 and the steering mechanism 12. The transmission shift indicator 20 is positioned adjacent to the transmission controller 15. The speedometer 18 and the tachometer 19 are easily visible to the user during use of the present invention, such that the user can control the speed and shift gears accordingly. While this is the preferred embodiment, the layout of the control panel 6 and performance display 8 may vary as long as the controls are easily accessible.

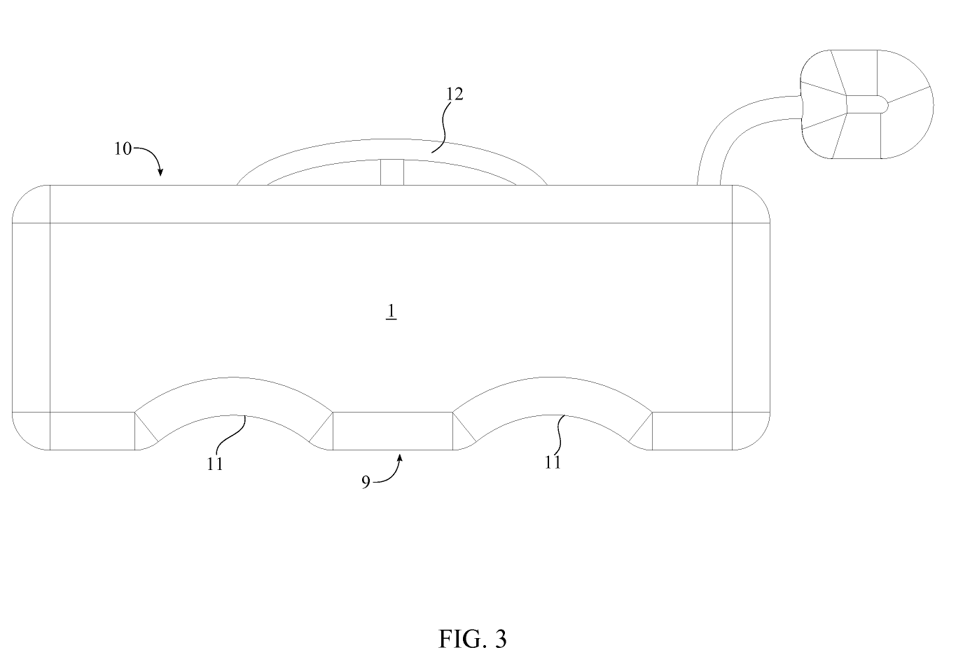

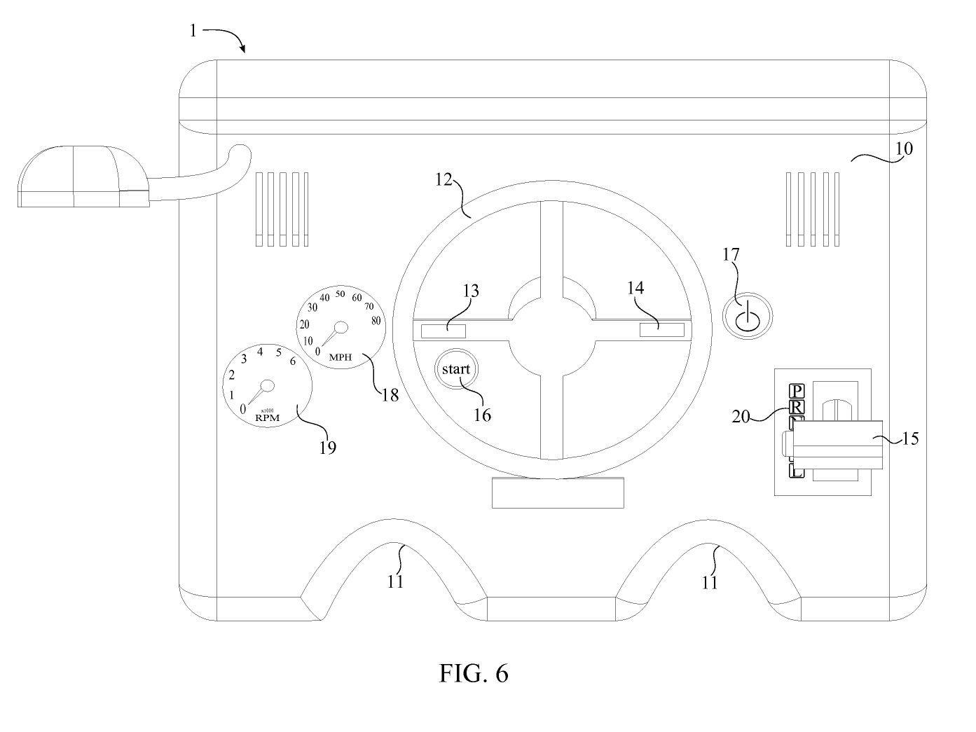

One object of the present invention is that it is portable such that the present invention may be used in an automobile, such that the user of the present invention may follow the route of the physical automobile. The present invention includes software that assess the position of the physical automobile and position a virtual automobile behind for the user of the present invention to control. This configuration allows the user of the present invention to ask questions directly to the driver to learn why certain decisions were made and how to operate the vehicle. In order to facilitate this aspect of the present invention, the enclosure 1 comprises a pair of leg rests 11, as shown in FIG. 1 to FIG. 3 and FIG. 6. The pair of leg rests 11 allows the present invention to sit comfortably on the users lap. The pair of leg rests 11 is integrated into the base 9 surface and offset from each other to comfortably sit the on the user while allowing the control panel 6 and the performance display 8 to be operable by the user. The steering mechanism 12 is positioned in between the pair of leg rests 11, such that the steering mechanism 12 is centrally positioned for the user.

The data storage device 2 houses a software program that allows the input from the GPS 5 to position a virtual vehicle on a map. The virtual vehicle is either viewed from a top down perspective where the user can view the surrounding roads or from a street view, parallel to the road, which is either the first person or third person perspective. The view is generated through the GPU 4 and outputted through the display adapter 7 to the external viewing device. The user controls the vehicle though the control panel 6 and monitors performance of the virtual vehicle via the performance display 8. The CPU 3 takes the input from the user and uses the rules provided by the software for handling these inputs to determine how the virtual vehicle responds.

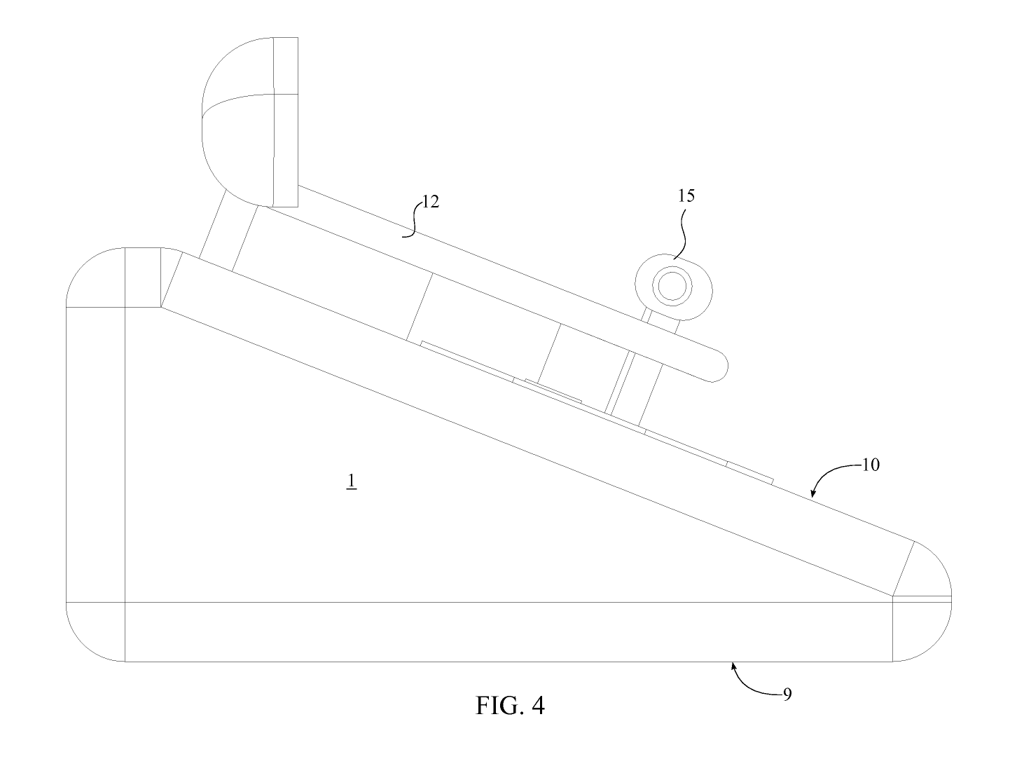

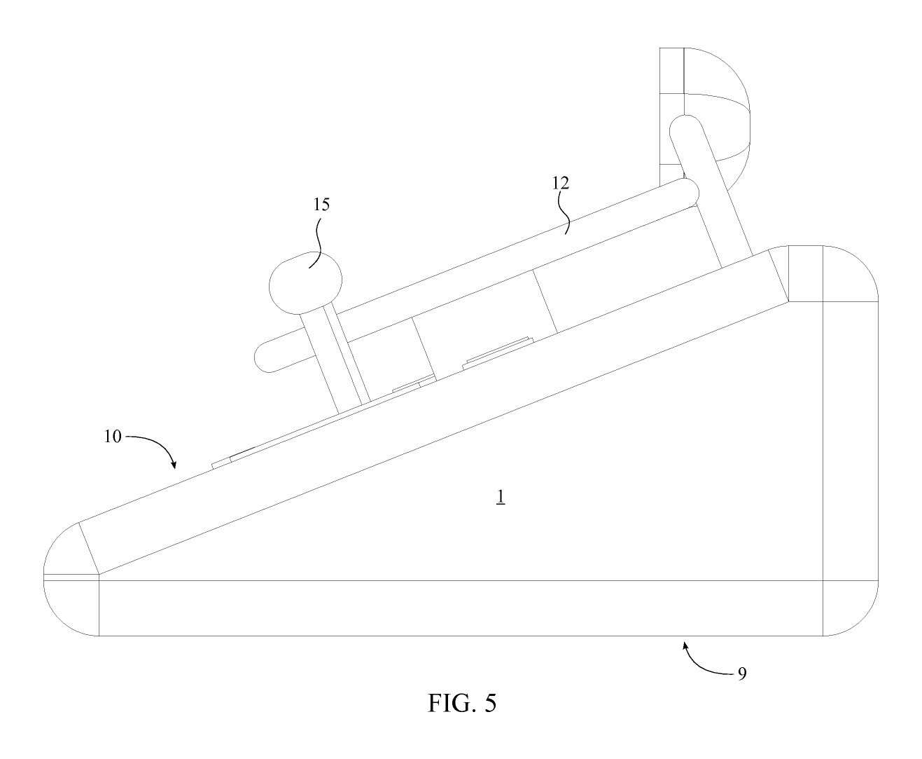

Further, the steering mechanism 12, shown in FIG. 1 to FIG. 7 is interchangeable between controller types. These controller types include, but are not limited to: a steering wheel, as previously mentioned; a joystick; a control pad; or wireless controllers. The steering mechanism 12 makes use of a potentiometer which varies the output signal based on the degree which the steering mechanism 12 is turned or manipulated by increasing or decreasing the resistance within a circuit. The wireless controllers communicate to the CPU through infra-red, Bluetooth, or other appropriate means for wireless signal transmission. The interchangeable controller allows for the present invention to be adaptable to play videogames, in addition to teaching the user how to drive, in order to provide the user with additional entertainment.

In some embodiments of the present invention, the control panel 6 further comprises adjustable vents, a radio, a clock, a mirror, and an auto-fire switch. The adjustable vents allow the user to mimic adjusting ventilation systems as in a physical vehicle. The radio and clock provide similar functionality as the adjustable vents where the user can practice viewing a clock and adjusting a radio while controlling the virtual vehicle.

Although the invention has been explained in relation to its preferred embodiment, it is to be understood that many other possible modifications and variations can be made without departing from the spirit and scope of the invention as hereinafter claimed.

What is claimed is:

1. A GPS based instructional driving simulation device comprises:
an enclosure;
a data storage device;
a central processing unit (CPU);
a graphical processing unit (GPU);
a global positioning system (GPS);
a control panel;
a display adapter;
the enclosure comprises an dashboard and a base;
the control panel comprises a steering mechanism;
the steering mechanism being centrally positioned on the dashboard;
the data storage device, the CPU, the GPU, and the GPS being positioned within the enclosure;
the control panel being mounted onto the dashboard;
the control panel being electronically connected to the CPU;
the GPS being electronically connected to the CPU;
the CPU being electronically connected to the data storage device; and
the CPU being electronically connected to the display adapter through the GPU.

2. The GPS based instructional driving simulation device as claimed in claim 1 comprises:
the control panel further comprises an acceleration controller, a deceleration controller, a transmission controller, an ignition button, and a power button;
the acceleration mechanism, the deceleration mechanism, the transmission controller, the ignition button and the power button being electronically connected to the CPU; and
the transmission controller, the ignition button and the power button being mounted onto the dashboard.

3. The GPS based instructional driving simulation device as claimed in claim 2 comprises:
the acceleration controller and the deceleration controller being a pair of paddle shifters; and
the pair of paddle shifter being operatively mounted onto a steering wheel of the steering mechanism.

4. The GPS based instructional driving simulation device as claimed in claim 2 comprises:
the acceleration controller and the deceleration controller being a pair of buttons; and
the pair of buttons being operatively mounted onto a steering wheel of the steering mechanism.

5. The GPS based instructional driving simulation device as claimed in claim 1 comprises:
a performance display;
the performance display comprises a speedometer, a transmission shift indicator, and a tachometer;
the speedometer, the transmission shift indicator, and the tachometer being electronically connected to the CPU; and
the speedometer, the transmission shift indicator, and the tachometer being mounted on the dashboard.

6. The GPS based instructional driving simulation device as claimed in claim 1 comprises:
a performance display;
the performance display comprises a speedometer, tachometer and a transmission shift indicator;
the control panel further comprises a transmission controller, an ignition button, and a power button;
the steering mechanism being positioned between the tachometer and the transmission controller;
the speedometer being positioned between the tachometer and the steering mechanism;
the ignition button being positioned between and equidistant to both the speedometer and the steering mechanism;
the power button being positioned between the transmission controller and the steering mechanism; and
the transmission shift indicator being positioned adjacent to the transmission controller.

7. The GPS based instructional driving simulation device as claimed in claim 1 comprises:
the enclosure comprises a pair of leg rests;
the pair of leg rests being offset from each other;
the pair of leg rests being integrated into the base surface; and
the steering mechanism being positioned in between the pair of leg rests.

8. A GPS based instructional driving simulation device comprises:
an enclosure;
a data storage device;
a central processing unit (CPU);
a graphical processing unit (GPU);
a global positioning system (GPS);
a control panel;
a display adapter;
a performance display;
the enclosure comprises an dashboard and a base;
the control panel comprises a steering mechanism;
the steering mechanism being adjacently and centrally positioned on the dashboard;
the data storage device, the CPU, the GPU, and the GPS being positioned within the enclosure;
the control panel being mounted onto the dashboard;
the control panel being electronically connected to the CPU;
the GPS being electronically connected to the CPU;
the CPU being electronically connected to the data storage device;
the CPU being electronically connected to the display adapter through the GPU; and
the performance display being mounted on the dashboard.

9. The GPS based instructional driving simulation device as claimed in claim 8 comprises:
the control panel further comprises an acceleration controller, a deceleration controller, a transmission controller, an ignition button, and a power button;
the acceleration mechanism, the deceleration mechanism, the transmission controller, the ignition button and the power button being electronically connected to the CPU; and
the transmission controller, the ignition button and the power button being mounted onto the dashboard.

10. The GPS based instructional driving simulation device as claimed in claim 9 comprises:
the acceleration controller and the deceleration controller being a pair of paddle shifters; and
the pair of paddle shifter being operatively mounted onto a steering wheel of the steering mechanism.

11. The GPS based instructional driving simulation device as claimed in claim 9 comprises:
the acceleration controller and the deceleration controller being a pair of buttons; and
the pair of buttons being operatively mounted onto a steering wheel of the steering mechanism.

12. The GPS based instructional driving simulation device as claimed in claim 8 comprises:
the performance display comprises a speedometer, a transmission shift indicator, and a tachometer; and
the speedometer, the transmission shift indicator, and the tachometer being electronically connected to the CPU.

13. The GPS based instructional driving simulation device as claimed in claim 12 comprises:
the control panel further comprises a transmission controller, an ignition button, and a power button;
the steering mechanism being positioned between the revolution indicator and the transmission controller;
the speedometer being positioned between the tachometer and the steering mechanism;
the ignition button being positioned between and equidistant to both the speedometer and the steering mechanism;
the power button being positioned between the transmission controller and the steering mechanism; and
the transmission shift indicator being positioned adjacent to the transmission controller.

14. The GPS based instructional driving simulation device as claimed in claim 8 comprises:
the enclosure comprises a pair of leg rests;
the pair of leg rests being offset from each other;
the pair of leg rests being integrated into the base surface; and
the steering mechanism being positioned in between the pair of leg rests.

15. A GPS based instructional driving simulation device comprises:
an enclosure;
a data storage device;
a central processing unit (CPU);
a graphical processing unit (GPU);
a global positioning system (GPS);
a control panel;
a display adapter;
a performance display;
the enclosure comprises an dashboard and a base;
the control panel comprises a steering mechanism;
the performance display comprises a speedometer, a transmission shift indicator, and a tachometer;
the steering mechanism being adjacently and centrally positioned on the dashboard;
the data storage device, the CPU, the GPU, and the GPS being positioned within the enclosure;
the control panel being mounted onto the dashboard;
the control panel being electronically connected to the CPU;
the GPS being electronically connected to the CPU;
the CPU being electronically connected to the data storage device;
the CPU being electronically connected to the display adapter through the GPU;
the performance display being mounted on the dashboard; and
the speedometer, the transmission shift indicator, and the tachometer being electronically connected to the CPU.

16. The GPS based instructional driving simulation device as claimed in claim 15 comprises:
the control panel further comprises an acceleration controller, a deceleration controller, a transmission controller, an ignition button, and a power button;
the acceleration mechanism, the deceleration mechanism, the transmission controller, the ignition button and the power button being electronically connected to the CPU; and
the transmission controller, the ignition button and the power button being mounted onto the dashboard.

17. The GPS based instructional driving simulation device as claimed in claim 16 comprises:
the acceleration controller and the deceleration controller being a pair of paddle shifters;
the pair of paddle shifter being operatively mounted onto a steering wheel of the steering mechanism;

18. The GPS based instructional driving simulation device as claimed in claim 16 comprises:
the acceleration controller and the deceleration controller being a pair of buttons; and
the pair of buttons being operatively mounted onto a steering wheel of the steering mechanism.

19. The GPS based instructional driving simulation device as claimed in claim 15 comprises:
the control panel further comprises a transmission controller, an ignition button, and a power button;
the steering mechanism being positioned between the revolution indicator and the transmission controller;
the speedometer being positioned between the tachometer and the steering mechanism;
the ignition button being positioned between and equidistant to both the speedometer and the steering mechanism;
the power button being positioned between the transmission controller and the steering mechanism; and
the transmission shift indicator being positioned adjacent to the transmission controller.

20. The GPS based instructional driving simulation device as claimed in claim 15 comprises:
the enclosure comprises a pair of leg rests;
the pair of leg rests being offset from each other;
the pair of leg rests being integrated into the base surface; and
the steering mechanism being positioned in between the pair of leg rests.
